(19) United States
(12) Patent Application Publication
(10) Pub. No.: US 2010/0057688 A1
(43) Pub. Date: Mar. 4, 2010

(54) ADAPTIVE MULTI-CHANNEL ANSWERING SERVICE FOR KNOWLEDGE MANAGEMENT SYSTEMS

(75) Inventors: Justin Anovick, Huntersville, NC (US); Charlie Isaacs, San Jose, CA (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(73) Assignee: Kana Software, Inc., Menlo Park, CA (US)

(21) Appl. No.: 12/204,698

(22) Filed: Sep. 4, 2008

(51) Int. Cl. G06F 17/30

(52) U.S. Cl. 707/3; 707/E17.001

(57) ABSTRACT

Embodiments of the invention provide a method, system and computer program product for automated selection of a channel of support dependant upon the behavior of the customer. In one embodiment, a method for agile channeling inquiries to a customer relationship management system can be provided. The method can include receiving an inquiry from a customer to a customer relationship management system over a computer communications network. The method also can include inspecting an environment pertaining to the inquiry and matching the inspected environment to a specific channel of communication amongst multiple different channels of communication supported by the customer relationship management system, for example Web content, an e-mail, a live chat and a live phone call. Finally, the method can include responding to the inquiry through the matched specific channel of communications. In this way, a specific channel of communication can be selected to optimally respond to the inquiry.

### BACKGROUND OF THE INVENTION

1. Field of the Invention

The present invention relates to the field of customer relationship management and more particularly to channel selection for customer relationship management systems.

2. Description of the Related Art

The corporate enterprise faces a difficult challenge when attempting to simultaneously improve the quality of customer service while reducing service costs. More products, growing product complexity and rapid change substantially increase the amount of information required to answer customer questions and troubleshoot problems. Paradoxically, this information overload has produced an information famine in which the growth of information availability increases the difficulty of finding relevant information—particularly in an online, automated computing environment.

For the corporate enterprise to improve self-service adoption rates, increase call center efficiency and improve response accuracy, solutions are required that assist each of agents, customers, partners and suppliers in finding answers to questions more efficiently. As a result, effective solutions to information search and retrieval have become critical to inquiry resolution. One popular approach includes deploying a search engine that allows users to sift through many information sources. Typically, search engines offer any or a combination of a keyword, simple text and natural language query interface.

While the utilization of a search engine for self-service information retrieval for inquiry resolution has become commonly understood, this approach has demonstrated significant limitations. In particular, the search engine is best suited for use by expert users who are familiar with the content and terminology being searched and who know which search words will most quickly yield a correct answer. However, users without domain expertise cannot easily apply the precision and relevance required for efficient retrieval. Most will recall the experience of entering a few keywords into a search engine only to receive a resulting set of hits numbering in the thousands.

To address the limitations of the basic search engine for information retrieval, the corporate enterprise has turned to the knowledge management (KM) system to better manage and share information. The KM system has been defined as an “IT (Information Technology)-based system developed to support and enhance the organizational processes of knowledge creation, storage/retrieval, transfer, and application.” The KM system intends to enable users to access to knowledge of facts, sources of information, and solutions of an organization in the course of inquiry resolution.

The modern KM system often takes the form of a document based system utilizing technologies that permit the creation, management and sharing of formatted documents. Advanced forms of the KM system include ontology based systems incorporating terminologies used to summarize a document, and artificial intelligence (AI) technologies utilizing a customized representation scheme to represent a problem domain. Generally, in a modem KM system, for inquiry resolution one or more answering servers process answer client requests for solutions statically with returned content, or actively with the conduct of a transaction.

Customer inquiries and requests for information retrieval in a customer relationship management system can be processed through multiple different channels. Generally, initial inquiries can be processed through a Web interface in which the customer actively seeks out information for inquiry resolution and the customer relationship management system—possibly a KM system—passively awaits customer inquiries. Elevated levels of customer support can be provided through different channels including e-mail, instant messaging (live chat) with a customer service representative and even live phone support. Intelligent customer relationship management systems detect the hesitancy of a customer when interacting with a Web page and proactively suggest a transition to a different channel of support—usually a live chat or live phone support.

### BRIEF SUMMARY OF THE INVENTION

Embodiments of the present invention address deficiencies of the art in respect to inquiry resolution for customer relationship management systems and provide a method, system and computer program product for automated selection of a channel of support dependant upon the behavior of the customer. In an exemplary embodiment of the invention, a method for agile channeling inquiries to a customer relationship management system can be provided. The method can include receiving an inquiry from a customer to a customer relationship management system over a computer communications network. The method also can include inspecting an environment pertaining to the inquiry and matching the inspected environment to a specific channel of communication amongst multiple different channels of communication supported by the customer relationship management system, for example Web content, an e-mail, a live chat and a live phone call. Finally, the method can include responding to the inquiry through the matched specific channel of communications. In this way, a specific channel of communication can be selected to optimally respond to the inquiry.

In one aspect of the embodiment, inspecting an environment pertaining to the inquiry can include inspecting an identity or a customer type of the customer. In another aspect of the embodiment, inspecting an environment pertaining to the inquiry can include inspecting a duration of time during which the customer interacts with a user interface to the customer relationship management system. In yet another aspect of the embodiment, inspecting an environment pertaining to the inquiry can include inspecting a known wait time for interacting with a customer service representative. Finally, in even yet another aspect of the embodiment, inspecting an environment pertaining to the inquiry can include inspecting a volume of phone calls being handled with other customers.

In another embodiment of the invention, a customer relationship management data processing system can be provided. The system can include a customer relationship management system executing in a host server and providing a Web based user interface configured to receive inquiries from customers over a computer communications network. The system also can include multiple different channels of communication supported by the customer relationship management system, for instance Web content, an e-mail, a live chat and a live phone call. Finally, the system can include agile channeling logic coupled to the customer relationship management system. The logic can include program code enabled to inspect an environment pertaining to an inquiry to the customer relationship management system received from a customer, to match the inspected environment to a specific one of the channels of communication, and to respond to the inquiry through the matched specific one of the channels of communications.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for agile channeling inquiries to a multi-channel customer relationship management system;

FIG. 2 is a schematic illustration of a multi-channel customer relationship management system configured for agile channeling of inquiries; and,

FIG. 3 is a flow chart illustrating a process for agile channeling inquiries to a multi-channel customer relationship management system.

### DETAILED DESCRIPTION OF THE INVENTION

Embodiments of the present invention provide a method, system and computer program product for agile channeling inquiries to a multi-channel customer relationship management system. In accordance with an embodiment of the invention, an inquiry to a multi-channel customer relationship management system can be retrieved. The environment associated with the inquiry can be determined, for example an identity of a person posing the inquiry, a duration in which the person posing the inquiry has interacted with a particular portion of the customer relationship management system, a known wait time for interacting with a customer service representative, a volume of inquiries in an inquiry queue, and the like. The determined environment in turn can be matched to a specific channel of communication provided by the multi-channel customer relationship management system. For example, the matched channel can include a Web interface, a live chat, an e-mail or a live phone call. Thereafter, a response to the inquiry can be provided over the matched channel of communication.

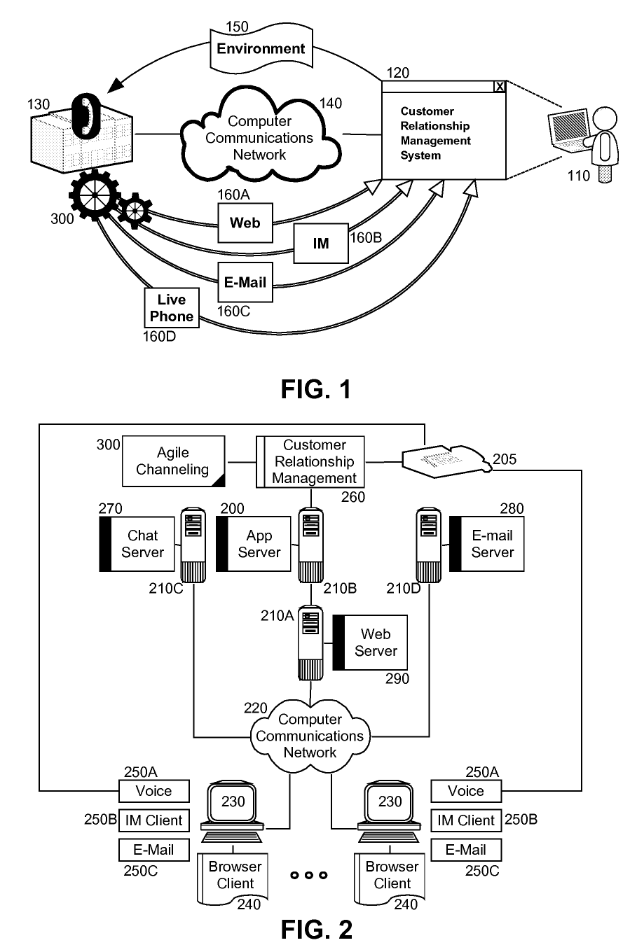

In illustration, FIG. 1 is a pictorial illustration of a process for agile channeling inquiries to a multi-channel customer relationship management system. As shown in FIG. 1, a customer 110 can interact with a customer relationship management system user interface 120 provided by a customer relationship management call center 130 over computer communications network 140. Specifically, the customer 110 can pose one or more inquiries to the customer relationship management system user interface 120 for assistance with a product or service supported by the customer relationship management call center 130. Agile channeling logic 300 included in association with customer relationship management call center 130 can inspect the environment 150 of the customer relationship management system user interface 120.

Through an inspection of the environment 150, agile channeling logic 300 can determine, for example the identity or type of the customer 110, the time during which customer 110 interacts with the customer relationship management system user interface 120, a known wait time for interacting with a customer service representative (not shown) at the customer relationship management call center 130, a volume of phone calls being handled by the customer relationship management call center 130 and the like. Responsive to the environment 150 of the customer relationship management system user interface 120, the agile channeling logic 300 can select a particular channel of communication 160A, 160B, 160C, 160D through which the inquiries of the customer 110 are to be answered. In this regard, the channels of communication 160A, 160B, 160C, 160D can include by way of example, a Web interface 160A, an instant messaging session (live chat) 160B, e-mail 160C, or a live phone call 160D. In this way, an optimal channel of communication can be selected through which inquiry answers can be provided according to the contemporaneous environment 150 of the customer 110.

The process described in connection with FIG. 1 can be deployed within a multi-channel customer relationship management data processing system. In further illustration, FIG. 2 schematically depicts a multi-channel customer relationship management system configured for agile channeling of inquiries. The system can include multiple different host servers 210A, 210B, 210C, 210D. One or more of the different host servers 210A, 210B, 210C, 210D can support the operation of one or more of an application server 200, a chat server 270, an e-mail server 280 and a Web server 290. In this regard, while each of the application server 200, a chat server 270, an e-mail server 280 and a Web server 290 are shown in FIG. 2 to execute in separate ones of the different host servers 210A, 210B, 210C, 210D, the skilled artisan will recognize that any combination of the application server 200, a chat server 270, an e-mail server 280 and a Web server 290 can execute in any combination of the host servers 210A, 210B, 210C, 210D.

A customer relationship management system 260 can execute in the application server 200. As part of the execution of the customer relationship management system 260, one or more Web pages can be provided by the customer relationship management system 260 through Web server 290. The provision of the Web pages provide a user interface to the customer relationship management system 260 over a computer communications network 220, such as the global Internet. As such, the Web pages can be displayed in browser clients 240 executing in respective client computing devices 230 for different customers posing inquiries to the customer relationship management system 260.

Each of the respective client computing devices 230 further can support additional channels of communication beyond a Web interface in the browser client 240, including a voice interface 250A for voice over Internet Protocol (IP) telephony, instant messaging 250B and e-mail 250C. One or more of the voice interface 250A, instant messaging 250B and e-mail 250C can be facilitated directly through the browser client 240 as a component of the browser client 240. Alternatively, one or more of the voice interface 250A, instant messaging 250B and e-mail 250C can operate separately from the browser client 240 as separate applications operating concurrently with but separately from the browser client 240.

Notably, agile channeling logic 300 can be coupled to the customer relationship management system 260. The agile channeling logic 300 can include program code enabled to identify an environment for an inquiry posed by a customer through a browser client 240. Responsive to the determination of the environment, the program code of the agile channeling logic 300 can be enabled to select a particular channel of communication through which the inquiry of the customer can be answered. By way of example, the particular channel of communication can include a telephonic channel between a phone 205 associated with the customer relationship management system 260, a live chat initiated by way of chat server 270 in connection with the customer relationship management system 260, an e-mail message originating from the e-mail server 280 in association with the customer relationship management system 260, or Web content provided through Web server 290 in connection with the customer relationship management system 260.

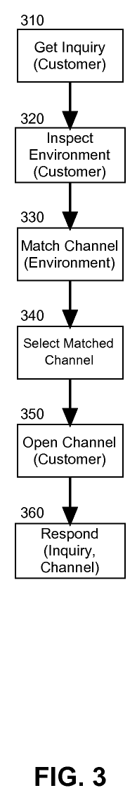

In yet further illustration of the operation of the agile channeling logic 300, FIG. 3 is a flow chart illustrating a process for agile channeling of inquiries to a multi-channel customer relationship management system. Beginning in block 310, an inquiry can be received from a customer over a computer communications network. In block 320, an environment for the inquiry can be determined. For instance, the environment can include the identity or type of the customer posing the inquiry, the time during which customer interacts with the customer relationship management system user interface, a known wait time for interacting with a customer service representative, a volume of phone calls being handled with other customers, and the like.

In block 330, a specific channel of communication can be matched with the determined environment and in block 340 the matched channel of communication can be selected through which the inquiry can be answered. In block 350, the selected channel of communication can be opened with the customer over the computer communications network. Finally, in block 360, the inquiry can be answered over the opened channel of communication.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for agile channeling inquiries to a customer relationship management system, the method comprising:
receiving an inquiry from a customer to a customer relationship management system over a computer communications network;
inspecting an environment pertaining to the inquiry;
matching the inspected environment to a specific channel of communication amongst multiple different channels of communication supported by the customer relationship management system; and,
responding to the inquiry through the matched specific channel of communications.

2. The method of claim 1, wherein inspecting an environment pertaining to the inquiry, comprises inspecting an identity of the customer.

3. The method of claim 1, wherein inspecting an environment pertaining to the inquiry, comprises inspecting a customer type of the customer.

4. The method of claim 1, wherein inspecting an environment pertaining to the inquiry, comprises inspecting a duration of time during which the customer interacts with a user interface to the customer relationship management system.

5. The method of claim 1, wherein inspecting an environment pertaining to the inquiry, comprises inspecting a known wait time for interacting with a customer service representative.

6. The method of claim 1, wherein inspecting an environment pertaining to the inquiry, comprises inspecting a volume of phone calls being handled with other customers.

7. The method of claim 1, wherein matching the inspected environment to a specific channel of communication amongst multiple different channels of communication supported by the customer relationship management system, comprises matching the inspected environment to a specific channel of communication selected from the group consisting of Web content, an e-mail, a live chat and a live phone call.

8. A customer relationship management data processing system comprising:
a customer relationship management system executing in a host server and providing a Web based user interface configured to receive inquiries from customers over a computer communications network;
multiple different channels of communication supported by the customer relationship management system; and,
agile channeling logic coupled to the customer relationship management system, the logic comprising program code enabled to inspect an environment pertaining to an inquiry to the customer relationship management system received from a customer, to match the inspected environment to a specific one of the channels of communication, and to respond to the inquiry through the matched specific one of the channels of communications.

9. The system of claim 8, wherein the channels of communications are channels of communication selected from the group consisting of Web content, an e-mail, a live chat and a live phone call.

10. A computer program product comprising a computer usable medium embodying computer usable program code for agile channeling inquiries to a customer relationship management system, the computer program product comprising:
computer usable program code for receiving an inquiry from a customer to a customer relationship management system over a computer communications network;
computer usable program code for inspecting an environment pertaining to the inquiry;
computer usable program code for matching the inspected environment to a specific channel of communication amongst multiple different channels of communication supported by the customer relationship management system; and,
computer usable program code for responding to the inquiry through the matched specific channel of communications.

11. The computer program product of claim 10, wherein the computer usable program code for inspecting an environment pertaining to the inquiry, comprises computer usable program code for inspecting an identity of the customer.

12. The computer program product of claim 10, wherein the computer usable program code for inspecting an environment pertaining to the inquiry, comprises computer usable program code for inspecting a customer type of the customer.

13. The computer program product of claim 10, wherein the computer usable program code for inspecting an environment pertaining to the inquiry, comprises computer usable program code for inspecting a duration of time during which the customer interacts with a user interface to the customer relationship management system.

14. The computer program product of claim 10, wherein the computer usable program code for inspecting an environment pertaining to the inquiry, comprises computer usable program code for inspecting a known wait time for interacting with a customer service representative.

15. The computer program product of claim 10, wherein the computer usable program code for inspecting an environment pertaining to the inquiry, comprises computer usable program code for inspecting a volume of phone calls being handled with other customers.

16. The computer program product of claim 10, wherein the computer usable program code for matching the inspected environment to a specific channel of communication amongst multiple different channels of communication supported by the customer relationship management system, comprises computer usable program code for matching the inspected environment to a specific channel of communication selected from the group consisting of Web content, an e-mail, a live chat and a live phone call.
